(19) United States
(12) Patent Application Publication
(10) Pub. No.: US 2021/0219757 A1
(43) Pub. Date: Jul. 22, 2021

(54) Cake Cover Candle Holder (CCCH)

(71) Applicant: Charles E. Griffin, JR., INGLEWOOD, CA (US)

(72) Inventor: Charles E. Griffin, JR., INGLEWOOD, CA (US)

(21) Appl. No.: 16/747,727

(22) Filed: Jan. 21, 2020

(51) Int. Cl. A47G 19/26; F21V 35/00

(52) U.S. Cl. CPC A47G 19/26; F21W 2121/002; F21V 35/00

(57) ABSTRACT

A line of specially designed transparent cake holders with covers, both circular and rectangular, and in several sizes comprising recessed, form-fitting holes or wells on top covers to hold birthday cake candles. Creating a germ-proof barrier between the candles (and the candle-blower) and the cake, as well as providing protection and storage for the cake, the design intent is to ensure that blowing out the candles on a cake is a safe, hygienic experience for all of those celebrating the occasion and consuming the cake. Once the cake is finished the cake holder and cover is made of a durable yet thin biodegradable plastic that can be recycled and decomposed of by the consumer.

### BACKGROUND OF THE INVENTION

### Field of the Invention

The present invention relates generally to the field of cake protector devices and more specifically relates to a line of specially designed transparent cake holders and covers, both round and rectangular, and in several sizes comprising recessed, formfitting wells on the top covers to hold cake candles.

### Description of Related Art

Upwards of 859,000 Americans celebrate a birthday on any given day; and that worldwide, some 19 million do. Add in such occasions as retirement parties, anniversaries, and other parties where candles are blown out before a cake is consumed, and you get a sense of the market for cakes and candles. The problem is this: Could there be anything less hygienic to do with a cake than have someone huff and puff and blow across it prior to consumption, raining their saliva across the surface of the cake leaving who-knows-what germs behind. Therefore, a need exists for a safer way of blowing out the candles.

Various attempts have been made to solve problems found in cake protector device art. Among these are found in: U.S. Pub. No. 2009/0181335 to Michael Tropeano; U.S. Pat. No. 4,938,688 to Ethel Wexler and U.S. Pub. No. 200710048680 to Cartledge et al. This prior art is representative of cake protector and candle holder devices.

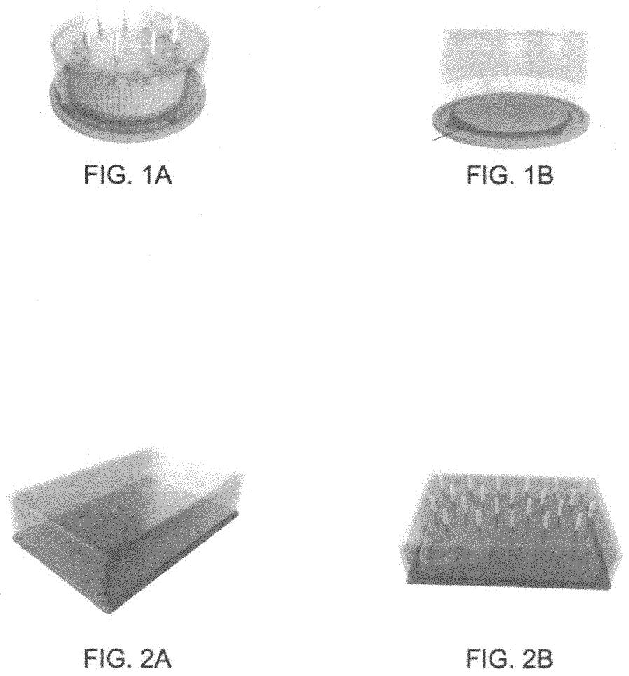

None of the above inventions and patents, taken either singly or in combination, is seen to describe the invention as claimed. Thus, a need exist for hygienic Cake Cover Candle Holder-CCCH, a line of specially designed transparent and disposable plastic, cake holders and covers, both round (FIG. 1A, 1B, 2A, 2B) and rectangular and in several sizes comprising recessed formfitting well on the top covers to hold cake candles and avoid the above-mention problems.

### BRIEF SUMMARY OF THE INVENTION

In view of the foregoing disadvantages inherent in the known cake protector device art, the present invention provides a novel Cake Cover Candle Holder-CCCH. The general purpose of the present invention, which will be described subsequently in greater detail, is to provide a line of specially designed transparent and disposable cake holders and covers, both round and rectangular; and in several sizes comprising recessed, form-fitting wells on the top covers to hold cake candles keeping the wells clean and clear; creating a germ proof barrier between the candles (and the candle blower) and the cake, as well as providing protection and storage for the cake, the design intent is to ensure that the blowing out the candles on a cake is a safe, hygienic experience for all of those celebrating the occasion and consuming the cake. The features of the invention which are believed to be novel are particularly pointed out and distinctly claimed in the concluding portion of the specification. These and other features, aspects, and advantages of the present invention will become better understood with reference to the following drawings and detailed description. Further, the wells are protected with a very thin disposable covering that peels off when ready to be used.

### BRIEF DESCRIPTION OF THE DRAWINGS

The figures which accompany the written portion of this specification illustrate embodiments and method(s) of use for present invention, Cake Cover Candle Holder-CCCH, constructed and operative according to the teachings of the present invention.

(FIG. 1A) shows a perspective view illustrating the circular model of the Cake Cover Candle Holder-CCCH with cake holder base and plastic top cover with wells for holding candles.

(FIG. 1B) shows a perspective view illustrating the circular model of the Cake Cover Candle Holder-CCCH emphasizing the rotational plate on the cake holder bases while the plastic top is removed

(FIG. 2A) shows a perspective view illustrating the rectangular model of the Cake Cover Candle Holder-CCCH with cake holder base and plastic top cover with wells for holding candles.

(FIG. 2B) shows a perspective view illustrating the rectangular model of the Cake Cover Candle Holder-CCCH emphasizing the plastic top cover with well for holding candles.

The various embodiments of the present invention will hereinafter be described in conjunction with the appended drawings.

### DETAILED DESCRIPTION

As discussed above, embodiments of the present invention relate to a cake protector device and more particularly to a Cake Cover Candle Holder-CCCH, a line of specially designed transparent cake covers, round and rectangular (FIG. 1A, 1B, 2A, 2B) and in several sizes comprising recessed, form-fitting well on the top covers to hold to hold the candles. Further, the wells are protected with a very thin disposable covering that peels off; creating a germ free-proof barrier between the candles (and the candle-blower) and the cake. Also providing protection and storage for the cake. The design intent is to ensure that blowing out the candles on the cake is a safe, hygienic experience for all of those celebrating the occasion and consuming the cake.

Referring now to drawings (FIG. 1A, 113, 2A, 2B). The Cake Cover Candle Holder-CCCH comprising a novel product offering consumers a practical solution to the aforementioned challenges. As the name implies, the Cake Cover Candle Holder-CCCH comprises a specially designed product line of candles. Candles could be left on top after candles are blown out, then cover is removed for cutting. Cake holders and covers to be produced in both rectangular and circular versions and in several sizes. Not only would these holders serve to protect a cake during transport and storage, but the transparent covers would feature recessed, form-fitting wells for the candles—and create a germ proof barriers between the candles (and the candle-blower) and the cake.

The Cake Cover Candle Holder-CCCH (FIG. 2A, 2B) would be produced in food-grade, injection-molded thermoplastic, firm but somewhat pliable. The rectangular version of the Cake Cover Candle Holder-CCCH would be produced in a variety of sizes to accommodate sheet cakes and sizes ⅛-sheet, ½-sheet, ⅔-sheet and full-sheet; the circular Cake Cover Candle Holder-CCCH (FIG. 1A, 1B) would be 10 inches in diameter and 7 inches in height Both versions feature a snap-sealing, locking, transparent disposable cover. Lazy Susan base (360 degree) which makes it easy to rotate the cake for cutting. The covers are designed not only to protect and seal the cake(s), for they are molded with multiple, regularly-spaced recesses or wells for the butt ends of cake candles, with space in the middle for a name or name-label. Further, the wells are protected with a very thin disposable covering the peels off when ready to be used.

The user would simply place the candles as desired in the wells (FIG. 1A, 113, 2A, 2B) of the cover, then light the candles to blown out in the customary fashion, before the cover is removed, and the cake cut and consumed. And because the cover is transparent, everyone can enjoy the cake's decoration as the candles are blown out. With the design of the Cake Cover Candle Holder-CCCH, the burning candles to be blown out are removed from the top of the cake and placed instead in the top of the cover, never touching the cake.

Thus, when the candles are blown out, none of the candle wax or the candle blower's germ carrying mucus or saliva reaches the surface of the cake. Not only does the Cake Cover Candle Holder-CCCH prevent person-to-cake, therefore there is no transmission of germs to cake. Cake Cover Candle Holder-CCCH will also keep insects, dust, and other contaminants off the cake, and after cake is eaten the user can dispose or recycle the thin plastic Cake Cover Candle Holder-CCCH. Clever in conception and thoughtful in design, this innovative line of healthy cake covers should find a wide enthusiastic market reception. The Cake Cover Candle Holder-CCCH is cost effective to produce in the embodiments, as shown in (FIG. 1A, 1B, 2A, 2B).

The embodiments of this invention described herein are exemplary and numerous modifications, variations and rearrangements can be readily envisioned to achieve substantially equivalent results, all of which are intended to be embraced with the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

A durable plastic material for both top cover and base bottom plate, as shown in (FIG. 1A, 1B, 2A, 2B). Further, the material can be recycled over and over, compatible of being down (decomposed) rapidly by the action of microorganisms. A biodegradable substance creates less trash.

1. A cake protector and candle holder device comprising:
a disposable plastic cake holder base;
a disposable plastic cake cover top with wells for holding candles.

2. A cake cover device as in claim 1, wherein said cake cover top is made for any shape and size cake;

3. A cake cover device as in claim 1, wherein said cake cover top further comprises numerous form-fitting wells with closed ends to hold candles which fall slightly below the said cake cover top surface.

4. A cake cover device as in claim 1, wherein said cake cover top further comprises a thin plastic material to cover wells that peel off when ready to be used.

5. A cake cover device as in claim 1, wherein said cake holder base has groves to secure said cake cover top.

6. A cake cover device as in claim 1, wherein said cake holder base further comprises a rotational cake plate with notches for turning the cake in either direction.

7. A cake cover device as in claim 1, wherein said cake holder base further comprises a rubber bottom piece to prevent movement on any surface.
